(19) United States
(12) Patent Application Publication
(10) Pub. No.: US 2014/0231637 A1
(43) Pub. Date: Aug. 21, 2014

(54) Apparatus for Distance Measurement Using Inductive Means

(71) Applicants: Kenneth Gerald Blemel, Albuquerque, NM (US); Peter Andrew Blemel, Albuquerque, NM (US); Francis Edward Peters, Albuquerque, NM (US); Todd Francis Peterson, Albuquerque, NM (US)

(72) Inventors: Kenneth Gerald Blemel, Albuquerque, NM (US); Peter Andrew Blemel, Albuquerque, NM (US); Francis Edward Peters, Albuquerque, NM (US); Todd Francis Peterson, Albuquerque, NM (US)

(21) Appl. No.: 14/187,225

(22) Filed: Feb. 21, 2014

Related U.S. Application Data
(60) Provisional application No. 61/850,655, filed on Feb. 21, 2013.

(51) Int. Cl. G01D 5/26

(52) U.S. Cl. CPC G01D 5/268
USPC 250/227.14

(57) ABSTRACT

A system that provides detection, annunciation, mitigation, and alleviation of stress attacks by executing algorithms based on measurement of intensity of light. The system determines to execute algorithms to take programmed action based on potential effects of a detected stress attack. The system can be used, for example, to determine the position of potential attacks to conduits that transport electricity, oil, gas, foodstuffs, water, people, and materials.

### CROSS-REFERENCE TO RELATED APPLICATIONS

The present application claims the benefit of Applicants' prior Provisional Patent Application No. 61/850,655, filed on Feb. 21, 2013.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

LIST OF REFERENCED DOCUMENTS
U.S. PATENT DOCUMENTS

| Patent Number | Issue Date | Inventor |
|---|---|---|
| 6,265,880 | July 2001 | Born et al |
| 4,988,949 | January 1991 | Boenning et al |
| 5,862,030 | January 1999 | Watkins, et al |
| 6,249,230 | June 2001 | Baldwin et al |
| 5,218,307 | June 1993 | Hiller |
| 6,868,357 | March 2005 | Furse, et. al |
| 7,590,496 | September 2009 | Blemel |
| 7,356,444 | April 2008 | Blemel |
| 7,277,822 | October 2007 | Blemel |
| 7,974,815 | July 2011 | Blemel |
| 7,049,622 | May 2006 | Weiss |
| 7,763,009 | July 2010 | Weiss |
| 7,329,857 | February 2008 | Weiss |
| 6,965,709 | November 2005 | Weiss |
| 3,074,265 | January 1963 | Symons |
| 3,610,025 | October 1971 | Brunner |
| 5,078,432 | January 1992 | Seiter |
| 5,754,122 | May 1998 | Li et al. |
| 6,035,717 | March 2000 | Carodiskey |
| 6,265,880 | July 2011 | Born et al. |
| 6,392,551 | May 2002 | De Angelis |
| 6,487,518 | November 2002 | Miyazaki et al. |
| 6,512,444 | January 2003 | Morris et al. |
| 6,630,992 | October 2003 | Vobian et al. |
| 6,762,419 | July 2004 | Kranz |
| 5,862,030 | January 1999 | Watkins |
| 6,259,996 | July 2001 | Haun, et al. |
| 6,242,993 | June 2001 | Fleege, et al. |
| 6,230,109 | May 2001 | Miskimins, et al. |

### NON PATENT DOCUMENTS

1. George F. Luger “Artificial Intelligence Structures and Strategies for Complex Problem Solving,” Addison Wesley 2002
2. Finn V. Jensen “Bayesian Networks and Decision Graphs,” Springer-Verlag, New York N.Y., 2001
3. Eugene Charniak, “Bayesian Networks without Tears,” AI Magazine 1991
4. Edward A. Bender, “Mathematical Methods in Artificial Intelligence,” IEEE 1996
5. C. Stern, M. Lee, “An Automated Model Calibration System Based on a New Method for Localized Component Calibration,” Proceedings of ICALEPCS'99, Trieste, IT
6. C. Stern, G. Luger, “Integrated Model-based Diagnosis and Control Automation,” Intelligent Ship Symposium III, Philadelphia Pa., Jun. 14-15, 1999, ASNE Press: Philadelphia Pa.
7. J. Kaipio and E. Somersalo, “Statistical and Computational Inverse Problems,” Vol 160, Applied Mathematical Sciences, Springer, 2004.
8. G. A. Seber and C. J. Wild, “Nonlinear Regression,” Wiley, Hoboken, 2003.
9. H. T. Banks, Zackary R. Kenz, and W. Clayton Thompson, “A review of selected techniques in inverse problem nonparametric probability distribution estimation,” CRSC-TR12-13, North Carolina State University, May 2012; J. Inverse and Ill-Posed Problems.
10. A. Mallet, “A maximum likelihood estimation method for random coefficient regression models,” Biometrika, 73:3 (1986), pgs 645-656.
11. M. Bartur, “Automatic Detection of Optical ‘Faults’ in Communications Networks,” March 2013, Optics and Photonics Journal, pp 179-182.

### BACKGROUND OF THE INVENTION

The present invention relates to the field of applied engineering, concerned with the application of technology for condition monitoring and prognostic health management to provide safety and enhanced key performance parameters, such as reliability and maintainability. The present invention relates to transparent fibers, strips, and strand, also known as fiber optics and optical fibers. Fiber optics are made of high quality extruded silica, about the thickness of a human hair. Extruded polymer fibers are “lossy” and impractical to use over 100 meters. Extruded glass optical fibers are widely used in fiber-optic communications. Fibers are also used for illumination; and are wrapped in bundles so that they may be used to carry images, thus allowing viewing in confined spaces, such as colonoscopy or rotor cuff repair procedure. Specially designed fibers are used for a variety of other applications, including sensors.

The present invention relates generally to an instrument for enhancing the safety of systems that carry exclusively or as mixtures; electrical, optical, electromagnetic signals, fluids, gases, or solids by determining and locating the identity of stress attacks and stress factors (stressors) that cause deterioration and damage affecting the health, status, and integrity of equipment, conduits, and conductive paths, as well as components thereof including cladding, insulating materials, conductors, and the signals or media they transport. Stress attack in this context include, but not limited to, abrasion, vibration, shock, stresses, strains, chemicals, and heat. More particularly, it relates to an instrumentation apparatus with a combination of active and passive components used in-situ for automated inspection periodically or in real time, or during periodic inspection with visual, instrument, or automated means to pro-actively identify, measure distance to, diagnose, and prognose damage and deterioration as well as the causes thereof.

The present invention more specifically relates to devices that measure three-dimensional (3-D) curvilinear distance; and more particularly, to devices that measure distance from a known location to unknown location to map the progress of a stress attack.

The present invention also relates to using artificial intelligence to understand the nature of the stress attack, as well as the probabilities for potential consequential damage to entities proximal to a stress attack.

The present invention also relates to protection from stress attack by taking action to prevent attack, such as, but not limited to, weather conditions, contamination, fire, flooding, rodents, corrosion, heat, and cold. In addition, the present invention relates to mapping the coordinates of current stress attack and prior stress attacks and use of context and inference to infer actual damage of damage to a proximal entity or risk that damage will occur if the stress attack continues.

The present invention relates to using inverse transforms that are based on previous data (priors) to accurately determine key factors such as the length of the receptor, location of a stress attack, or distance to damage of a conduit. This includes using inference reasoning such as, “If the length is less than the original length (the prior), the length is the distance and location to damage to the receptor and by inference there is an 80 percent likelihood of damage to a nearby entity within the hour.”

The present invention also relates to using differential comparisons to identify the location of defects and damage to supporting communication and electrical conduits, such as, but not limited to, incisions, penetrations, and corrosion.

The present invention relates to using photons from light sources, which, without limitation, can be laser, fluorescent, incandescent, and sunlight. The light from a light source can, at any mixture of frequency, amplitude and power, include collimated light from a laser. The light can be continuous or pulsed.

If left undetected and allowed to take its course, the damage caused by a stress attack can cause damage of said components grounding, shorting, leaks of substances carried in containers, and conduits. The damage can occur in moments or take an extended period of time. Often the failure happens unexpectedly, before a system's operator knows of the problem.

In practice, conduits are usually encased by an insulating material and sometimes sheathed with one or more layers of cladding to assure continued functionality and safety. Conduits and systems of conduits may carry electrical power, fuel, other fluids, pneumatics, optical, or electromagnetic signals. Deterioration and damage to cladding and insulation can be, and often is, a precursor to a failure in a system. Damages to interconnection systems include, but are not limited to, chafing due to vibration, corrosion due to caustic chemicals, incisions due to sharp edges, stress and strain due to motion, burning, oxidation, reduction and other chemical reactions, as well as chemical and physical degradation due to aging. In certain situations, it is important to know the degree of risk and status of integrity of conduits and components that comprise them.

We focus now on vehicle and aircraft wiring as conduits, although the following statements have broad application in other uses for conduits of other types in other applications. In older, fly-by-cable aircraft, chafed, cut electrical harnesses, control cables, and hydraulic conduits used to control flight surfaces, landing gear, fuel supplies, and engines, have been known to cause loss of control of the aircraft and fatal crashes. In current fly-by-electric aircraft, electrical signals are carried by metal conductors spread through encased harnesses with tens of wires each to thousands of end points. Some wires are more critical than others, such as for operating wheels, avionics, control surfaces and propulsion system components. Damaged electrical wires with exposed conductors are known to result in electrical shorts resulting in numerous instances of fire, crashes, and fatality. Cabins filled with smoke are also common, resulting in scary situations and aborted flights. For example, the Federal Aviation Administration has implicated damage to or deterioration of electrical conduits as the root cause of failure in reports. An electrical wiring short is cited as a probable cause of the explosion in the center fuel tank of the 1996 incident involving TWA flight 800 Boeing747 aircraft. A similar situation exists with when fiber optic conduits are broken in fly-by-light aircraft control systems, mass transit systems, or industrial control systems, to name a few instances.

Severe chafing can cause exposure or damage to the conduit or that which is causing the chafe. In either case, the results can be catastrophic as witnessed by the report of the NTSB investigation of the 20 Jul. 1992 crash of a V-22 that attributed the cause as chafing by an electrical conduit resulting in chafe through of a titanium hydraulic conduit releasing its contents.

By law, or decision in recognition of sufficient risk, conduits are usually required to have reactive safety devices such as electrical circuit breakers, temperature and pressure sensors, and relief valves as the means to protect against hazards. In many cases, visual and intrusive inspections are used to assure functionality and safety.

Damage to aircraft conduits is known to cause catastrophic failure due to loss of signals to control systems, loss of hydraulic fluid, and other situations. Even when control systems remain intact, toxic fumes and dense toxic smoke from smoldering or fire caused by heat from an electrical short can make it impossible for a pilot to safely fly the aircraft. Intense heat from burning aromatic polyimide electrical wiring insulation and other combustibles can melt other insulation in seconds leading to collateral damage, more shorts, and further loss of control. As a result, commercial aircraft are now required to have smoke detector alarms.

Considering the extreme safety hazards of loss of control, toxic fumes, toxic smoke, fires, or fuel tank explosions of aircraft, it is not only important to know that deterioration or damage such as chafing is occurring that, left unattended, will likely result in arcing or cut wires; further that a chafing situation exists that likely will cause arcing or cut wires to happen during flight. It would be very desirable therefore to have an advance warning or corrective action initiated by an in-line or in-situ passive means for the purpose of detecting evidence of significant causes of deterioration, damage, and failure of conduits, as well as the degree of ongoing deterioration and damage. It would be even more desirable if electricity were not the means of detection of said ongoing deterioration and damage.

### DISCUSSION OF PRIOR ART

The following discussion presents limitations of prior art, or those aspects not covered by prior art, that are addressed by the present invention. For brevity, only the most significant limitations of each category of prior art are included.

The problem of the prior art is its complexity, inability to solve real-world problems, the need for bulky apparatus, and numerical processing of algorithms, which adds weight and increases cost.

Our search of patent databases discovered over two hundred U.S. patents that deal with detection of faults in electrical signals, detection of damage, and deterioration in operating equipment, electrical conductors, in electrical power systems, oil and gas distribution systems, along with patents of similar nature applied to deterioration and damage of pipelines, fiber optic networks and other conduits. Almost all of the said patents do not address detecting stressor attack or calculating the location of where the stress attack is taking place before damage, deterioration, and unsafe condition has occurred.

Prior art that teach single-ended sensing with processing signals of reflected waveforms to determine and locate damage to conduits is limited to un-branched conduits because complex branched conduits have distance ambiguities, since several branches will traverse the same reflected distance. Our web and patent searches found systems and apparatus and methods that employ collimated light from lasers and optical domain reflectrometry analytics to compute distance to a fracture or termination in an optical-grade glass or plastic fiber to monitor temperature and pressure within conduits, as well as leaking liquids and gases from damaged conduits.

Our searches found no patents or applications that address unambiguously predicting, detecting, and locating stressor attacks with controls to pre-empt, ameliorate, or mitigate damage in complex systems with a single-ended device taught by the present invention because with other methods, the calculated distance could be more than one branch that has the same calculated distance giving an ambiguous result.

Our searches found there is currently nothing is in wide use that utilizes measurement of intensity of induced or collected light with an inverse transform to compute distance to point of damage to conduits such as, but not limited to, electrical wiring harnesses, fiber optic cables, or hydraulic lines Our searches found nothing is in wide use employing inductive light response and an inverse transform to accurately determine distance to point of damage on surface, in sheath, or within branched conduits using un-collimated light. Use of uncontained electrical signals is often dangerous and hazardous especially when conduits carry flammable or explosive matter, yet currently nothing is in wide use that enables calculating distance damage by un-collimated light means.

Currently nothing is in wide use that teaches unambiguous distance calculation using measurements from a single-ended sensor to locate stressors that will cause damage, or have caused damage to a conduit. In particular, there is nothing that teaches unambiguous distance calculation using measurements from a single-ended sensor to locate points where heat, strain, or other stressor is causing an unsafe condition in an electrical conduit before an open circuit, or a short circuit, or grounding of a circuit happens.

Patent searches in preparation of this application have not found prior art that provides a means for enabling inexpensive automated distance calculation for location of stressor attack and damage to equipment and conduits that do not rely on electricity means. Said searches have not found prior art that utilize inductive illumination of translucent media as a means for measuring distance for locating damage to the conduit insulation and, by implication, the conductor therein.

U.S. Pat. No. 4,988,949 by Boenning et al is limited to teaching detecting a short circuit caused by mechanical damage (chafing) on electrical cables against grounded structures under constant monitoring. Boenning et al does not teach locating the distance to the fault before the short occurs.

Watkins U.S. Pat. No. 5,862,030 teaches an electrical safety device comprised of a sensor strip disposed in the insulation of a wire or in the insulation of a sheath enclosing a bundle of electrical conductors, where the sensor strip comprises a distributed conductive over-temperature sensing portion comprising an electrically conductive polymer having a positive temperature coefficient of resistivity which increases with temperature sufficient to result in a switching temperature. Watkins' patent does not teach a means to perform detection of mechanical damage without use of an electrically conductive sensor material. Watkins' patent does not teach detecting stressor attack, or use of optical measurements, or measuring distance to locate the point of heating.

Baldwin et al U.S. Pat. No. 6,249,230 discloses a ground fault detection system and ground fault detector. Baldwin does not teach means to identify the curvilinear distance to or location of ground faults.

Haun et al U.S. Pat. No. 6,259,996 and Fleege et al U.S. Pat. No. 6,242,993 teaches arc fault circuit breakers that act to interrupt in real time on detection of arcing electrical faults, but it may be too late to avert disaster. Haun et al do not teach how to calculate curvilinear distance to the arcing electrical fault.

Patents dealing with diagnosing arc and ground faults have limitation because they do not assist detection of the stress attack before the arc or ground fault problem occurs and do not assist repair people in locating the place of where the problem occurs in order to correct the situation and any damage caused. The present invention overcomes limitations of the said arc and ground fault circuit breakers for two reasons. First, the present invention can detect conditions prior to when an unsafe condition or trouble occur. Second, the present invention does not require signal processing algorithms, signal digitizer or signal processor to accomplish measuring curvilinear distance to intermittent faults by calculating the curvilinear distance with a simple inverse transform giving the length of the elongated receptor terminated by damage at the point of the fault.

It is a limitation when prior art such as Hiller U.S. Pat. No. 5,218,307 and Miskimins U.S. Pat. No. 6,230,109 that require manual intervention when inspecting electrical and conduits of hazardous materials for finding defects and failures. The present invention overcomes this limitation by using light conducted in translucent media laid on or in a conduit before damage occurs and an optical interface to a photodetector further coupled to a controller comprised of a processor, means to send messages and means to execute actions to mitigate, ameliorate, control, or eliminate the stress attack.

Furse, et al U.S. Pat. No. 6,868,357 teaches how to use a frequency domain reflectometry (FDR) in metal conduits to measure distance to an impedance after a short circuit or open circuit has happened. Furse et. al. does not teach how to calculate distance to damage in non-metallic materials that surround and/or protect a conduit.

Blemel, U.S. Pat. Nos. 7,590,496, 7,356,444, 7,277,822 and 7,974,815 teach how to release a dye substance on chafing a fiber that is released along the conduit which a maintainer must find to locate points of damage. Blemel does not teach accurately calculating the curvilinear distance to the point of damage.

Weiss, U.S. Pat. No. 7,049,622 teaches using measurement of light intensity induced into a translucent fiber to measure distance to the surface of a fluid and distance to point of separation of immissible fluids. Weiss but does not teach using light to measure length of the fiber receiving the induced light.

In the June 2013 article, “Automatic Detection of Optical ‘Faults’ in Communications Networks,” (incorporated in its entirety by reference above, Bartur states: “Today there is no proven method for automated monitoring of the optical fiber cable plant in the aggregation and data center segments of private campus or public communications networks. Metrics at the higher network layers may identify that a problem exists, but they cannot quickly isolate the location of an optical fiber fault nor can they automatically trigger the immediate dispatch of repair technicians.

“An efficient, fast, physical layer monitoring approach is needed which can instantaneously identify, locate and report (via SNMP) any optical fiber cuts, breaks or other faults (as well as any open, damaged or dirty optical connectors) in the optical fiber cable plant. New technology is now available to accomplish this, which is backward compatible with legacy networks, and also forward compatible with new DWDM, 10G (and beyond) emerging networks, and may be easily integrated into SNMP monitoring of existing Switch/Router Equipment with minimal software/firmware upgrades.

### OBJECTS AND ADVANTAGES

One object of the present invention is to provide means to detect and locate stress attack, and locate damage to components by measuring intensity of light collected by a translucent media from, or induced by, light emitted by a proximal translucent photon emitter to calculate the length of the receptor, which, if less than a previously measured length, indicates where damage will likely occur to a conduit before the component integrity is compromised.

Another object of the present invention is to provide a single-ended sensor employing light in translucent media to eliminate ambiguity of which branch of a branched conduit is stressed, at risk, or is actually damaged by employing the present invention.

Another object of the present invention is to provide a means to eliminate ambiguity of which branch in a branched conduit is subject to stress attack, is at risk or is actually damaged by employing the present invention.

Another object of the present invention is to provide a means to sense and locate stress attack, stressors, and damage that does not depend on electricity to excite sensor material or read the sensor.

Another object of the present invention is to assist repairpersons in locating stress attacks and stressors, not limited to corrosives, heat, or chafing, by providing the curvilinear distance to the point where a stressor has damaged the sensor.

Another object of the present invention is to accurately detect and locate stress attack points to enhance the safety, performance, reliability, and longevity of systems by sensing risk of damage and evidence of actual damage and deterioration. This is of particular value for branched systems, which include, but are not limited to, electrical and optical harnesses, communication cables, pipelines for transporting liquids and gases, hydraulic and fuel lines, heating cores and tapes, aqueducts, and sewers. Components of conduits that can be monitored by the present invention include, but are by no means limited to, the supports, sheathing, cladding, insulation, junctions, electronics, and conductors that embody said conduit and the media transported by the conduit. Causes in this context include, but are not limited to, chemicals, mechanical stress, erosion, corrosion, heat, moisture, oxidation, reduction, electricity, and contamination.

Another object of the present invention is to calculate curvilinear distance, which provides means to calculate the location of stressors and damage the stressors cause.

Another object of the present invention is to provide data to diagnose cause of damage including, but not limited to, mechanical damage (chafing), corrosion, and heat, with the advantage that the detection and diagnosis is prior to any damage to the system monitored or to systems in the vicinity.

Another object of the present invention is measuring the rate of stressor attack with the advantage of enabling pre-emptive actions through knowledge of the degree and speed of attack, and if the speed is slow enough, to take pre-emptive action prior to any damage.

Another object of the present invention is to annunciate stress attacks and information about the stressors and take programmed action that provides mitigation, melioration, alleviation, and prevention to reduce local and collateral damage by employing the present invention.

The present invention provides ability to calculate rate of damage by a stressor by using two or more sensors deposed so that a first sensor is damaged before the second one and so on. The time to damage each sensor provides information on the rate of stress and damage.

A final object of the present invention is to provide a means and method that operates in a timely fashion to warn of stressor attack, to detect first symptoms of damage, to monitor damage in progress, and possibly pre-empt catastrophic damage that would otherwise occur.

There is an important and significant advantage in using data from measurements of characteristic parameters of light collected by strands of sensitized medium without the use of electrical excitation or reflectometry interrogation to measure curvilinear distances. Individually, the purpose of the sensors, comprised of translucent material constructed in the manner of the present invention, is to collect light that is coupled to a detector that provides intensity of light data for measuring the curvilinear distance to damage on continuous or multi-branched conduits with an inverse transform.

There are important and significant advantages to employing the invention, such as the ability to detect stressor attack and determine the location where stressor damage will take place or is taking place that infers of current damage to the system and eventual collateral damage. In the case of electrical conduits, the damage can be hidden inside thickly-shielded cables with multiple conductors making direct measurement impossible while inductive measurement of curvilinear distance taught in the present invention provides an accurate solution. In the case of aircraft wiring and conduits conducting dangerous chemicals, such damage detected before the stressor affects the performance of the conduit could mean the difference between life and death. As a minimum, the invention has the advantage to implement condition based maintenance, which is a procedure of choice in maintaining important systems such as pipelines, conduits, electrical systems, communication systems, data systems, and other uses of conduits. In any event, there is the advantage of having the ability to accurately detect stressor attack, to locate and infer the presence of stressors, to locate the point or points of attack and assesses the potential damage and associated risks due to the location of the damage. Such information will be of use to operators, safety inspectors, or repairpersons. This will be of particular advantage when the system of conduits is not easily inspected, perhaps hidden inside a wall, buried underground, in space systems, aircraft, naval vessels, and photovoltaic (PV) power systems.

The advantages of the present invention are not limited to situations involving conduits, but extend to the insulation material and other protection devices. An example of such an advantage is found in aircraft wiring systems where insulation is often made from aromatic polyimide called Kapton, which is known to explode and cause fires when the insulation degrades over time to form carbide molecules, which release flammable acetylene gas when wet. The present invention can be employed to detect location of ingress of moisture and fluids by using soluble coatings in the sensor construction.

It is an advantage that the present invention can be implemented with a computer or controller for real time in-situ diagnostics, prognostic of catastrophic affects and situation awareness of whereabouts of dangerous stress. It a major advantage of the present invention to send messages and execute control actions that ameliorate, mitigate, or protect from effects of stress.

It is an advantage of the present invention that it can be so constructed in other embodiments without a controller and light emitters in a manner that facilitates attachment of the controller or other suitable processor, and light emitters during manual inspections without disassembly of the conduit.

It is an advantage of the present invention that the sensor can be configured within a surface or it can be placed on or can be sleeved over a surface. The present invention thus enhances and protects the existing insulating and protecting material while providing enhancements to current visual inspection techniques and also to inspection using non-visual measurement systems during operations, inspections, tests, and repairs. When embodied in, or added to, a branched interconnection system, system of conduits or pipeline, the invention provides a means for ready and accurate determination of location and degree of damage.

Another advantage of the present invention over prior art is it provides a means to determine curvilinear distance to assess damage by stressors in accessible and inaccessible areas that are external to the conduit or other object they present invention serves to protect such as, but not limited to, inside pipelines and electrical harnesses.

It is an advantage of the present invention that safety risks are avoided, because the present invention enables use of light to measure curvilinear distance avoiding the safety risks inherent in using electricity.

It is an advantage of the present invention that the measurement does not require removing conduits that employ the sensor technique taught by the present invention.

It is an advantage of the present invention that the instrument can be located at either end of the sensor.

It is an advantage of the present invention that the sensor can be branched to follow the branches of a branched system requiring monitoring for actual or incipient damage; enabling discrimination of which branch of the sensor is damaged, and calculating the curvilinear distance to the point of damage of the sensor; even if the sensor branch is hidden under obstructions, in channels, underground, undersea, or other places where direct measurement is physically impossible.

Accordingly, besides the objects and advantages described in the above paragraphs, several objects and advantages of the present invention are: (a) to provide a means for unattended surveillance and real time inspection of integrity of branched systems; (b) to provide accurate estimate of the curvilinear distance to location of damage so as to facilitate remedial action; (c) to provide a means to be pro-active by enabling and providing for early location identification of the sensor of the present invention before damage to the more important object in proximity; and (d) to provide information to maintenance and safety personnel where a situation exists that, left unattended, could lead to damage of components and disrupting the system.

### BRIEF DESCRIPTION OF THE DRAWINGS

An apparatus and method for using mathematical inference and light rays to determine curvilinear distance is provided. The novel aspects of this invention are set forth with particularity in the drawings and appended claims. The invention itself, together with further objects and advantages thereof, may be more readily comprehended by reference to the following detailed description of presently preferred embodiments of the invention, taken in conjunction with the accompanying drawings. The medium used throughout the drawings are for example only.

This invention relates to an instrumented system for monitoring stress attack and collateral damage by using optical sensors and measuring length thereof in a curvilinear coordinate system. The instrumented system comprises: sources of light, emitter of light, translucent fibers, and strands or pieces of translucent media to conduct light to photodetectors that produce signal indicative of light properties.

Various embodiments of the invention are disclosed in the following detailed description and accompanying drawings.

FIG. 1 is a block diagram of a system comprised of entities and interconnection which is protected by instrumentation of the present invention.

FIG. 2 is a cutaway diagram of the interior of an exemplary embodiment of a curvilinear sensor constructed according to the present invention.

FIG. 3 is an explosion view diagram of the sensor of FIG. 2

FIG. 4 is a perspective view of a sensor with six spaced-apart pairs of emitters and receptors

FIG. 5 is a perspective view of three pairs of rectangular emitters in close proximity to three rectangular receptors.

FIG. 6 is a perspective diagram with a cutaway view of the interior of an exemplary embodiment of a sensor posited on a surface.

FIG. 7 is a perspective exploded view of an exemplary ribbonized multi-sensor constructed with six undamaged translucent receptors positioned proximal above six translucent emitters on an opaque material.

FIG. 8 is a perspective diagram which shows an exemplary cutaway diagram of a sensor constructed with six translucent receptors each with a pattern of opaque coating positioned proximal above six translucent emitters in an opaque material

FIG. 9 is a perspective view of three translucent receptors proximal to a translucent emitter; one receptor with a noble metal coating, one receptor with base metal coating, and one receptor with opaque water-soluble coating adjacent to a translucent emitter; all inside a sleeve of opaque material.

FIG. 10 is a perspective view of six rectangular receptors above a single flat translucent emitter.

FIG. 11 is a perspective view of a a translucent emitter with a side emitting feature constructed in accord with the present patent

FIG. 12 is a perspective cutaway view which shows diagrammatically an emitter with inward reflecting coating emitting light flux through a side-emitting feature to a proximal and parallel receptor.

FIG. 13 is a planar view of a sensor with melt caused by an hot resistive junction.

FIG. 14 is a perspective view diagram of a multiplicity of sensors constructed in a branched tree with splitters at the root junctions of branches.

FIG. 15, is a perspective view of FIG. 14 with one branch damaged by a stressor.

FIG. 16 is a block diagram which shows how light flux diminishes at couplings and is amplified with optical amplifiers.

FIG. 17 is an perspective view of an exemplary embodiment of a sensor with a translucent emitter proximal and parallel to a translucent receptor; the pair sheathed within an opaque material

FIG. 18 is a diagram of how measurement of length of a receptor is accomplished with aan inverse transform based on priors and light intensity measurement.

### REFERENCE TO NUMERALS USED IN DRAWINGS

1 Control Station
2 Branches
3 Melt
4 Upper End
5 Sensor Tree
6 Opaque Material
7 Side-Emitting Feature
8 Light Source
9 Light Flux
10 Receptor Flux
11 Light Reflecting Surface
12 Damage
13 Instrumentation
14 Optical Repeater
15 Coupling
16 Mounting Surface
17 Receptor
18 Electrical Junction
19 Emitter
20 Photodetector
21 Processor
22 Pattern of Opaque Coatings
23 Noble Metal Coating
24 Base Metal Coating
25 Opaque Water-Soluble Coating
26 Stresses
27 Splitter
28 Power Conduit
29 Generating Equipment
30 Transmission Equipment
31 Translucent Polymer Strand
32 Power Distribution Equipment
33 Receptor Strand with Inward Reflecting Coating
34 Receptor Strand with Organically-Soluble Coating
35 Control Conduit
36 Communication System
37 Process Control Equipment
38 Monitoring Equipment
39 Alternative Energy System
40 Battery
41 Machinery
42 DC to AC Converter

### DESCRIPTION OF TERMS

The term, “control conduits,” used herein are entities that conduct signals to control and power entities.

The term, “communication system,” is used herein to denote combinations of entities that perform message passing with wired or wireless means.

The term, “process control equipment,” is used herein to denote an entity that controls one or more processes such as, but not limited to, manufacturing, security, energy generation, and distribution, propulsion, and communications.

The term, “monitoring equipment,” is used herein to denote an entity that actively or passively monitors without limitation, capabilities, health state, and functions of other entities.

The term, “alternative energy system,” is used herein to denote combinations of entities that produce energy with limited use of fossil fuels such as, but not limited to, solar photovoltaic, wind, water, and geothermal.

The term, “energy storage system,” herein is used herein to denote an entity the stores energy for future consumption.

The term, “machinery,” is used herein to denote an entity that performs work.

The term, “DC to AC converter,” is used herein to denote an entity that converts direct current into alternating current.

The following additional terminologies are hereby defined so as not to have ambiguity of what a terminology refers to.
1. Radially is defined as exiting or entering from an edge (as in a radius of a circle)
2. Transmitting axially means from an end point (as in axle of a car.)
3. Select a control algorithm—the source could be non-volatile memory or other location in the instrumentation or from a cloud location.
4. Autonomous means capable of operating under self control
5. Map coordinates is defined as data that identify a precise location with reference to an architect drawing, installation schematic or global positioning system reference.
6. A threshold signal is a metric that if exceeded causes an action. The threshold could be stated as greater than or less than a certain reference value.
7. Entities includes but is not limited to equipment, machinery, conduits, wiring harnesses, vehicles, aircraft, and ships.

### DETAILED DESCRIPTION OF THE DRAWINGS

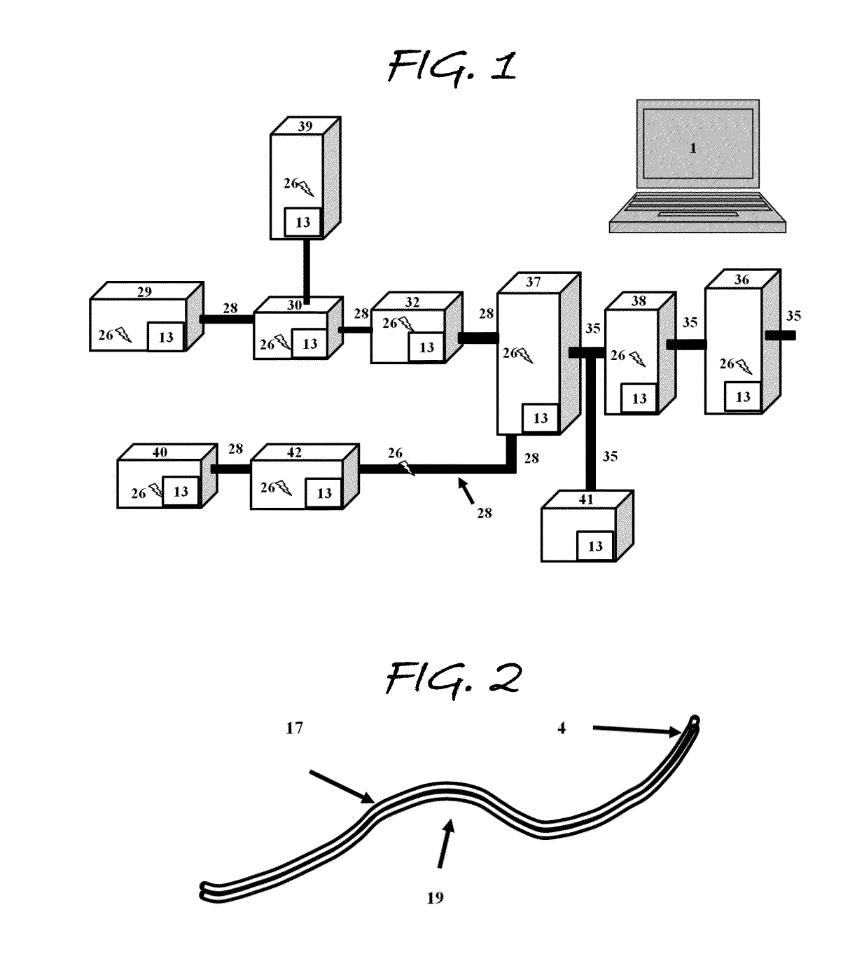

Referring now to FIG. 1 which is a block diagram which represents a system of electrical equipment monitored by instrumentation according to the present patent.

In FIG. 1 Direct Current is conducted from generating equipment 29 and an alternative energy system 39 on power conduit 28 to transmission equipment 30 where power conducted on a power conduit 28 to power distribution equipment 32. The power distribution equipment 37 supplies power to a process control equipment 37 that sends controls on a control conduit 35 to machinery and to monitoring equipment 38. Output from the monitoring equipment goes on a control conduit 35 to communication equipment 36 which communicates to a control station 1. Each element in FIG. 1 has a symbol for stresses 26 which will eventually lead to failures and potential collateral damage.

Still referring to FIG. 1. In the lower part of FIG. 1 DC power flows on a power conduit 28 from a storage battery 40 into to a DC to AC converter connected by power conduit 28 to the process controller 37. Each block in the diagram also has an instrument of the present invention that serves to monitor the system to detect stresses from stress attacks that can be from natural, process or man made sources. The instrumentation communicates by conduit (shown) or by wireless to the control station 1 and further the instrumentation has executes controls through the process control equipment to mitigate stresses and extend operating life of the equipment. The controls can be sent as messages on the power conduits (28) or the control conduits (35

Referring now to FIG. 2, The upper end 4 of a translucent receptor 17 emits light contained therein. The light intensity is the result of interaction of the translucent material of the receptor 17 with light from the proximal emitter 19 entering along its length. (An opaque material coating or encasing the emitter 19 and receptor 17 is omitted in order to show the interior construction.) If the receptor is doped with a fluorescent compound a first wavelength of ultraviolet light from the emitter 19 could induce a second wavelength of light in the receptor 17.

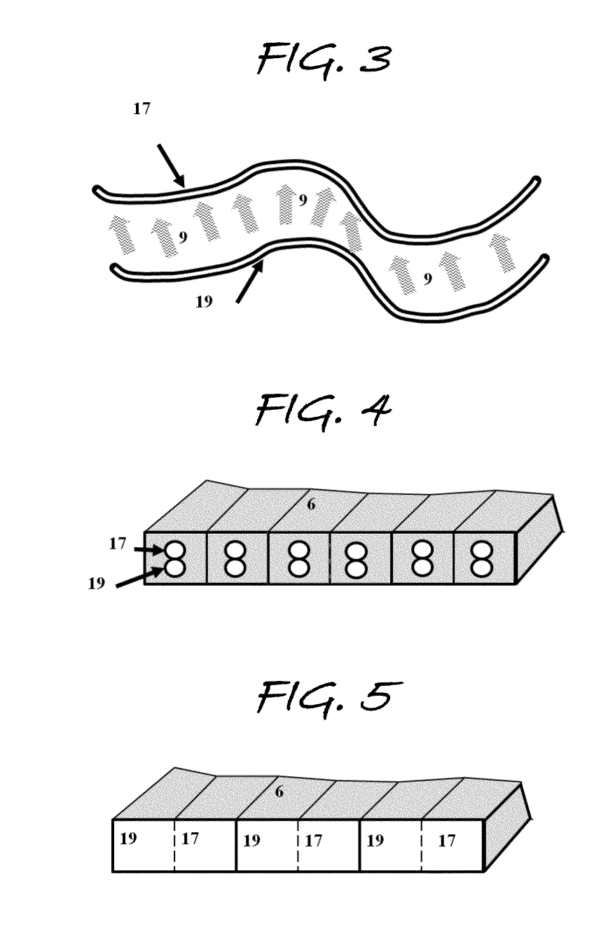

FIG. 3, is an explosion view diagram of the sensor of FIG. 2 showing light flux 9 from the emitter 19 shining onto the receptor 17. (An opaque casing material is omitted to show the interior of the sensor.

Referring now to FIG. 4 which is a diagrammatic view of a sensor with six spaced-apart pairs of translucent receptors 17 each vertically deposed above a translucent emitter 19 with the proximal surfaces touching so that light passes into the receptor 17. The six pairs are shown individually embedded in an opaque material 6 forming a ribbon of sensors. The individual translucent receptors 17 and individual translucent emitters 19 can be made of any translucent media.

Referring now to FIG. 5, which is a perspective view of three rectangular translucent emitters 19 parallel to three rectangular translucent receptors 17. The outer edges are depicted as opaque while the inner surfaces are depicted as translucent with dotted line indicated that light passes between. The individual translucent receptors 17 and individual translucent emitters 19 can be made of any translucent media. An opaque material 6 encasing the sensors is shown on the surface.

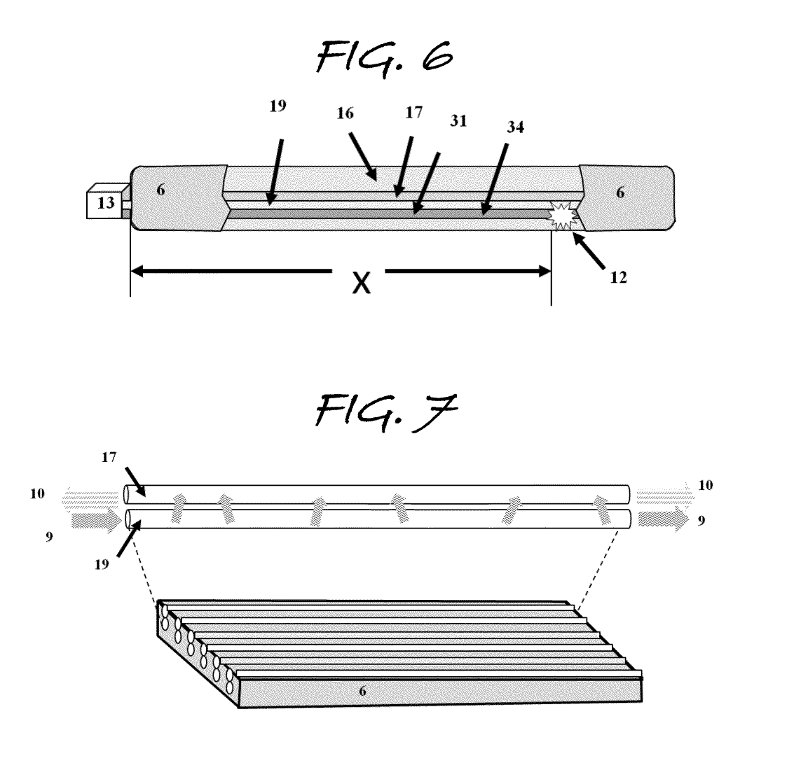

Referring now to FIG. 6, which is a diagram of an interior view of an embodiment of a sensor posited on a mounting surface 16 according to the present invention. The instrumentation 13 interfaces to sensor containing two translucent receptors 17 each of different composition; one a translucent polymer strand 31 and the other a translucent receptor strand with organically-soluble coating 34. A translucent emitter 19 is depicted between the two receptors. Damage 12 has interrupted light flow in the upper receptor 17. An inverse transform calculates distance “x” to the point of damage. FIG. 6 is purposely drawn with a cutaway between the right and left ends of opaque material 6 to show the interior construction.

Referring now to FIG. 7, which shows a perspective view of an exemplary embodiment of ribbon construction with six receptors posited proximal above six translucent emitters 19. The six sensors are embedded in an opaque material 6. The upper part of FIG. 7 is an explosion view where light flux 9 enters an emitter 19 and escapes radially into a receptor 17. Note that some light flux 9 flows from the right end of the emitter 19. Receptor flux 10 generated by the light flux 9 is guided in the receptor 17 and exits both ends. Note that opaque material 6 above the sensor is omitted to show the interior construction. The diameters of the strands are shown with exaggerated diameter. The ribbon of sensors could continue and be interfaced with light repeaters for great distances.

FIG. 8, is a perspective diagram which shows an exemplary cutaway diagram of a sensor constructed with six translucent receptors 17 each made with a spaced apart pattern of opaque coating. The receptors 17 are proximal above six translucent emitters 19 and the six pairs are show in posited in an opaque material 6. The upper part of FIG. 7 is an explosion view where light flux 9 enters an emitter 19 and escapes radially into a receptor 17. Note that some light flux 9 flows from the right end of the emitter 19. Receptor flux 10 generated by the light flux 9 is guided in the receptor 17 and exits both ends. Note that opaque material 6 above the sensor is omitted to show the interior construction. The diameters of the strands are shown with exaggerated diameter. It should be observed that the spaced apart coating makes the receptor less accurate because light cannot be received along its length. The ribbon of sensors could continue and be interfaced with light repeaters for great distances. An upper opaque material encasing the media is omitted to show the interior construction.

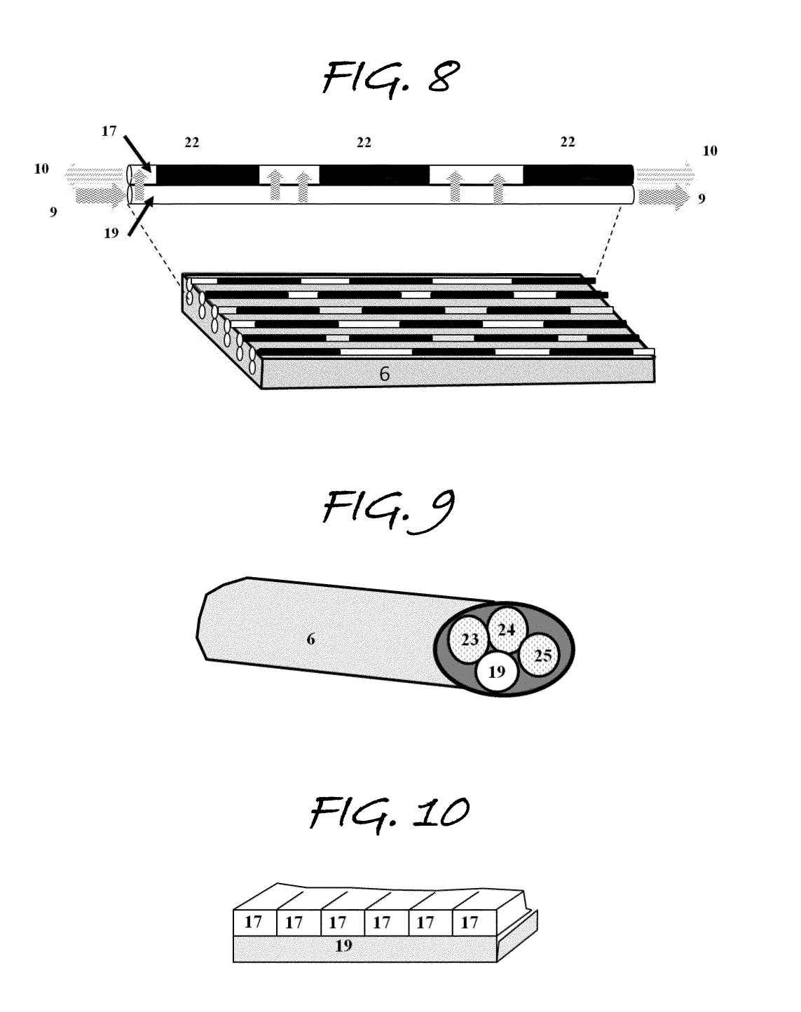

Referring now to FIG. 9, which is a perspective view of a three encased translucent strands; one with noble metal coating 23, one with base metal coating 24, and one with opaque water-soluble coating 25 adjacent to a single translucent emitter 19. The three are inside a sleeve of opaque material 6 in a circular arrangement

Referring now to FIG. 10, which is a perspective diagram of six receptors 1) made with rectangular media posited above a single emitter 19 which illuminates all the receptors 17. Optional opaque surrounding material is omitted to show the interior construction. The translucent emitters 19 and translucent receptors 17 are shown without a surface coating in an embodiment that would suited for installation embedded in an opaque material.

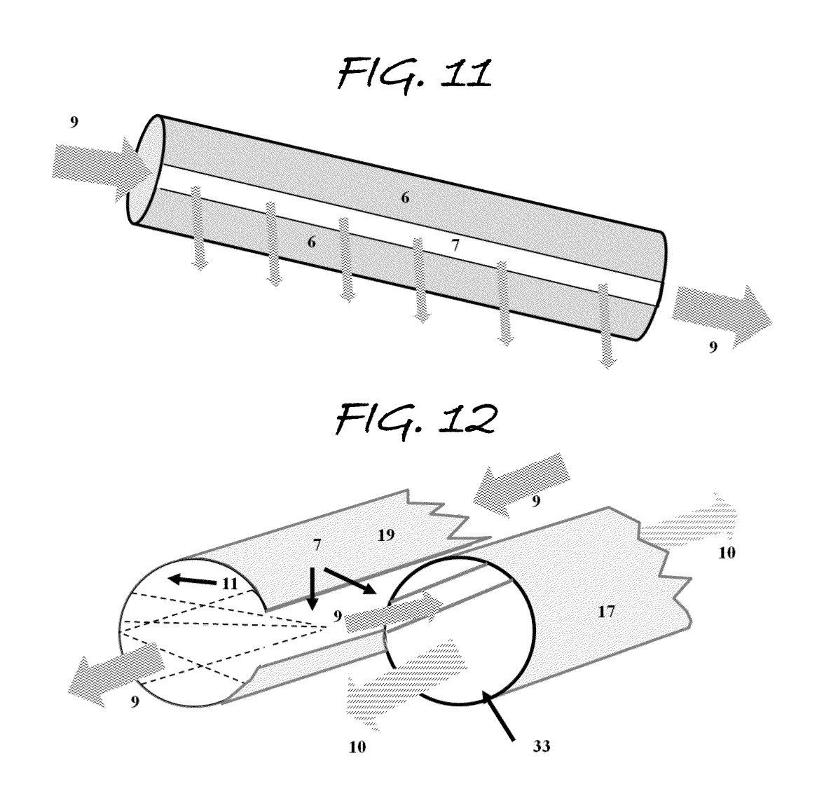

Referring now to FIG. 11, which is a perspective view of a strand of translucent material with side-emitting feature 7 which can be produced by applying an opaque material 6 in less than full circumference. The feature allows light flux 9 to flow in or out of the material in a radial direction along the length.

Referring now to FIG. 12, which shows diagrammatically how a receptor strand with inward reflecting coating 33 that focuses light flux 9 from the emitter 19 through a side-emitting feature 7 that runs notionally the length into a translucent receptor 17 with a similar side-emitting feature. The translucent emitter 19 has a light reflecting surface 11 to redirect the light from the emitter 19 into the translucent receptor 17, and the receptor flux 10 in the receptor is guided axially in both axial directions.

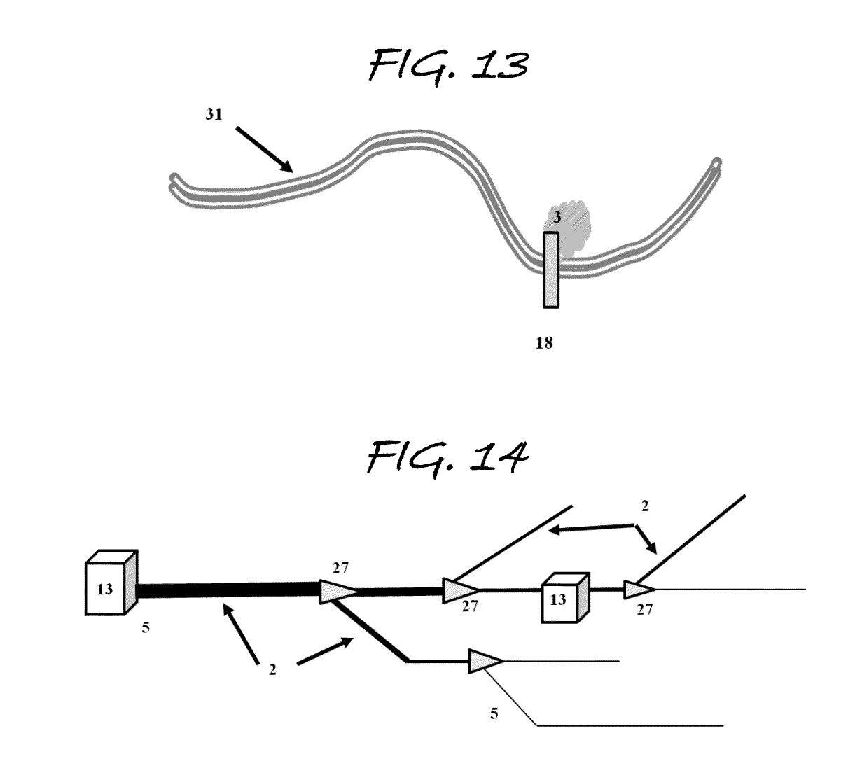

Referring now to FIG. 13, which shows diagrammatically how translucent polymer strand 31 could melt 3 due to: 1) heat, such as from a proximal resistive electrical junction 18. A translucent polymer strand 31 will melt at a lower temperature than a glass strand. A coating is omitted to show the interior of the sensor. The process of diagnostic logic can be extended to other stressors, such as a corrosive chemical, using logic that the intensity of light increases in a strand with base metal coating, but not for a strand with noble metal coating. Another example would be diagnosing chaffing by a hard object by using logic that erosion causes the intensity of light to increase for strands that have an erodible coating but not diamond coating. The sensitized construction will be individually selected based on the specific stressors in the operational environment.

Referring now to FIG. 14, which shows diagrammatically how a multiplicity of sensors can monitor the multiplicity of branches, such as often found in an electrical harness. The instrument 13 will measure from the first end of the sensor trunk 5 which in a preferred embodiment would be proximal to a photodetector in the instrumentation 13. Branching of the sensor tree 5 is accomplished by splitters 27 that allow a quantity of strands to flow uninterrupted into a branch while the remainder continue on. There should be no ambiguity where damage occurs as to which branch is at risk because each branch is instrumented.

Referring now to FIG. 15, which shows diagrammatically how a multiplicity of sensors from a first instrumentation 13 on the left forming branches that would follow branches of a conduit such as common in an construction of electrical harnesses and pipelines. Another instrumentation 13 is shown on the right as different logic may be needed to determine the cause of a stress attack that produced damage 12).

Each instrumentation 13 will be able to measure the curvilinear distance to damage 12 in the branches of the sensor tree 5 coupled to the instrumentation 13 nearest respective branches 2. Branching of the sensor tree 5 is accomplished by splitters 27 that separate each section of the sensor tree 5 to follow the next branch forward in the harness. Unlike with reflectometry, there will be no ambiguity as to which branch is at risk because each branch has a separate branch of the sensor tree 5.

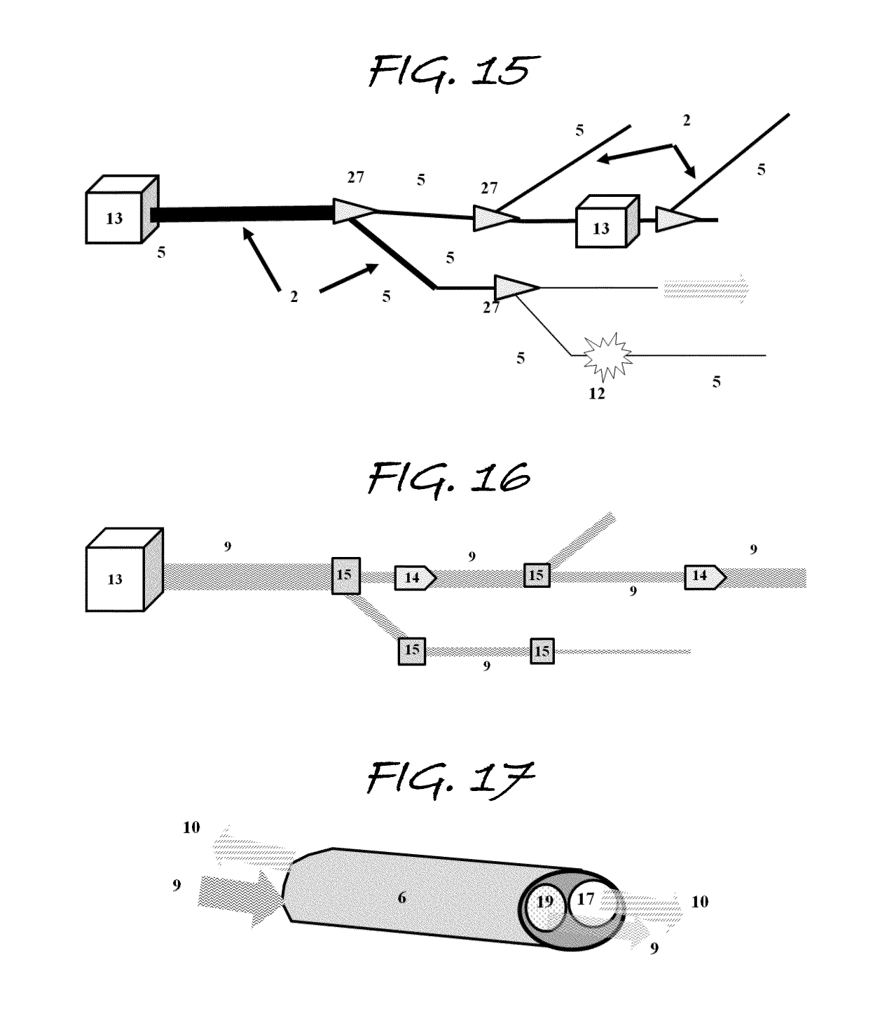

Referring now to FIG. 16 which is a flow diagram wherein the lower branch shows how light flux 9 diminishes with length once it exits from the instrumentation 13 due to effects such as, but not limited to, untight or scratched lens, as well as particulate in couplings 15, reflections at curves, defects, impurities, and other impedances. The purpose of optical repeaters (which are widely used in fiber optic networks), is to restore flux to a desired intensity. The top branch shows use of optical repeaters 14 to maintain the quality of light flux 9 should distances or operational situations require.

Referring now to FIG. 17 which is an exemplary embodiment of a sensor with a translucent emitter 19 proximal and parallel to a translucent receptor 17 sheathed within an opaque material 6. Light flux 9 enters the emitter 19 and a portion radiates into the receptor 17. Receptor flux 10 is guided bi-directionally in the receptor 17.

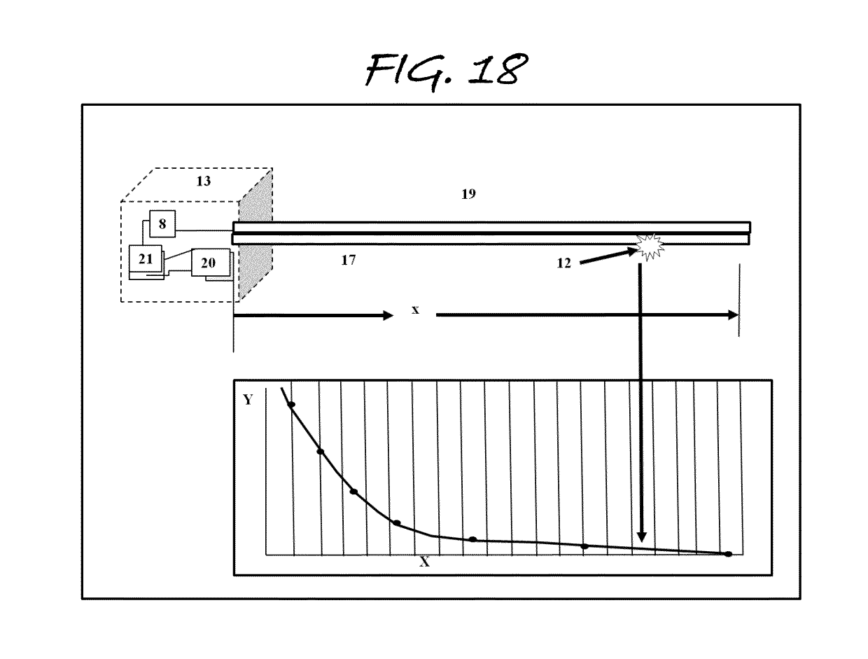

Referring now to FIG. 18, which shows an exemplary embodiment of the current invention.

In FIG. 18 instrumentation 13, including a processor 21 and associated electronics. The Light source 8 couples to an emitter 19 which emits light flux 9 axially. The flux is collected by a proximal and parallel receptor 17. A photodetector 20 produces a signal indicative of the light intensity from the translucent receptor 17. A point of damage 12 reduces the original length of the receptor 17. The processor 21 receives the light intensity signal from the photodetector and calculates length X of the receptor 17 with an inverse transform created with prior data collected by foreshortening one or more similar receptors 17.

Referring again to FIG. 18. The curve shown in the graph fits tuples of data collected during testing. Wherein Y is measure of intensity of light from the receptor 15 collected during testing and induced by light from the emitter 19. X is the length of the receptor 17 that produced Y. The length of the receptor from end point to damage 12 is produced by an inverse function calculated by a curve fitting application.

Referring again to FIG. 18 a person familiar with automated measurements would appreciate the monotonicity of the graph, further that complex bending of an optical sensor will have little or no effect on the calculation of the length ‘x’. Further, a person familiar with creating photonic sensors would appreciate that the straight construction of the sensor in FIG. 18 is the maximum extension and a curved sensor will produce the same ‘X’ as that produced by a straight sensor.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

In order to achieve the objectives of the above mentioned, the present invention provides a system made up of a method and an apparatus, the apparatus comprising:

a multiplicity of heterogeneous discrete strands of material, each naturally sensitive, or specifically made to be sensitive to stressors or the damage caused thereby by coating, cladding, or doping or other means, with at least one media substance specific to a class of anticipated stressor or anticipated damage caused by stressors; and,

a substrate, matrix, mesh, substance or surface which forms or encases said strands in a measurable pattern; and,

at least one electronic processing device of a type called an automated controller, or an interface to another suitable processor with ability to digitize, process, and perform pre-stored algorithms of calculus and logic; control a device that sends light into the said strands; and receive data from a light measurement means; and,

at least one receptor means for collecting light emissions from proximal light source means wherein the intensity of the collected light when measured at one end of the receptor relates monotonically to the length of said at least one receptor; and,

at least one light signal generator at least sufficient for the purpose of illuminating the number of emitter strands that are able be excited.

Signal generators in this context are producers of optical signals needed to operate a sensor.

Sensors in this context are devices that that can be placed in proximity to serve purpose to provide curvilinear distance measurement data communicating with the one or more photodetectors.

Photodetectors in this context are devices that change voltage or current when exposed to photons.

The said multiplicity of heterogeneous sensitized strands, photodetectors, and controllers serve as a means for achieving the objectives of the present patent, which include, but are not limited to, sensing, detecting, locating, measuring and messaging about stressors, and imminent or actual damage to, or deterioration of, objects in immediate proximity.

Branches in this context are divergences extending from along the sensor.

Side emitting property in this context means having areas along the length of a receptor or emitter that permit light flow axially in a portion or the entire axial surface.

In accordance with the present invention, elongated optical fibers are used to build the sensor that provides data that is used by an algorithm, which produces a measure of the length of the fiber.

In accordance with the present invention, altered length of a fiber in a sensor infers actual or potential damage to proximal objects.

In accordance with the present invention fibers are translucent with side emitting property so that fibers internal to a sensor either receive or emit light into each other.

In accordance with the present invention, there are two types of fibers; 1) an emitter that conducts light from an external source and emits light from one or more portions of the longitudinal surface; 2) a receptor that has one or more translucent areas on the axial surface, which permit flux to enter the receptor.

In accordance with the present invention, a receptor can be sensitized with analine or other dopant that emits light at a second wavelength when exposed to a primary wavelength.

In accordance with the present invention, primary type fibers can be sensitized with analine or other dopant that emits light at second wavelength when exposed to a primary wavelength.

In accordance with the present invention, the fiber can be of any translucent material.

According to conventional design practices, the instrumentation can be constructed in an electrically isolated package, optically coupled to the optical emitter(s) and receptor(s).

The apparatus of the present invention provides a means to obtain, baseline, and learn from data; the means to learn and fuse data to probabilistically assess causal factors of damage; the means to quantify the state of deterioration and damage that has occurred; the means to assess the risk that a situation exists that likely will soon cause deterioration or damage to happen; and the means to formulate and communicate messages about the state of deterioration, damage, risks of damage and causal factors.

In accordance with the present invention, a sensor is constructed of lengths of polymer or silica fiber. Before extrusion, the polymer or silica can be doped with a chemical that produces light at a second wavelength when excited by a primary ultraviolet wavelength.

In accordance with the present invention, a layer, sleeve, or tape made of a multiplicity of said strands of media coated, doped, and otherwise sensitized to anticipated conditions within, and external to said conduits, then adding the constructed apparatus as an appliqué, sheathing, weaving or winding to the outer or inner surface of an object such as a wiring harness or conduit.

In accordance with the present invention, ancillary electronics that are not an integral part of the apparatus (such as personal computers), signal conditioners (used for instruments not included in the apparatus) should be selected so as to be able to be readily interfaced to the apparatus.

In accordance with the present invention, the controller and other electronics should be packaged with foresight to prevent damage to itself or other entities.

In accordance with the present invention, the substrate, mesh, or surface on which optical fibers are formed, overlaid, or attached can be of any suitable material.

In accordance with the present invention, when used in communication with a commercially available computer, the calculated curvilinear distances, data, causal inferences, probabilities, and messages generated by the instrumentation of the present invention can be used by the computer to probabilistically predict future local, system, and end effects of faults and failures as well as remedial actions.

In accordance with the present invention, a sensor is constructed using polymer or silica fibers. The fibers can be joined or spliced to other optical fibers using optical repeaters to reach long distances using commercially available optical fiber connectors.

The said instrumentation provides the means to collect and process data obtained with algorithms to detect and probabilistically determine a stress attack and extent of damage, as well as predict future damage and the progression of effects of failures on the system monitored.

The present invention benefits from discrete sensors that provide the means to sense local configuration, usage, threat, and environmental data. Types of said discrete sensors include, but are not limited to, devices for measuring humidity and temperature and other available data. The said discrete sensors provide the means to detect deterioration and damage as well as detect factors that would affect the monitored system and the service it provides.

The said multiplicity of sensors is selected for each application primarily as a means to provide data about distance to deterioration, damage, or causal factors; and secondarily to provide a means to locate places where deterioration, damage, or threat of damage exists. In a preferred embodiment, the sensors would be laid out in a measurable pattern. Ideally, for detecting risk of small stressors, the pattern of sensors should repeat a pattern in a space of less than one centimeter to avoid not sensing problems such as a projectile penetration, pinhole leak, or a small electrical arc.

The remote computer should be selected for the ability to communicate with the controllers or perhaps indirectly with a system computer that communicates with the said controller by wired or wireless means.

Collectively, curvilinear distance measurements from the controller provides spatial data to use with artificial intelligence algorithms to make a probabilistic identification of the causes of stress; predict the type of damage being wrought; estimate the degree of damage incurred; estimate risks and consequences, and remaining time before failure occurs. The remote computer provides the means to communicate in real or elapsed time to persons who are at risk, who provide maintenance services, or who otherwise need to be aware of deterioration, damage, or risk thereof to the conduit and the services it provides.

### Preferred Embodiment

In a best embodiment, there is at least one controller with integral processor, or other processor coupled to a control means. There is at least one light source coupled to at least one sensor, which comprises one or more emitters constructed with elongated translucent media that guide the emitted light. There is at least one receptor constructed with one or more strands or pieces of translucent media that guide light. The receptor is parallel and proximal to at least one emitter so as to receive along its length light flux emitted axially from at least one emitter. Ideally, a proximal emitter and receptor are encased and protected by an opaque cladding to keep artificial light or daylight from entering the receptor. Further, the receptor guides the light within to a photodetector that: 1) outputs signal information proportional to intensity of light flux guided by the receptor; and 2) communicates the signal information to at least one controller or other processor which processes the signal information to calculate length x of the receptor.

Still discussing a best embodiment, the pattern of a multiplicity of sensors is connected with the said controller at least at one end. If situations may arise where additional controllers are required due to the distance involved, this can be readily accomplished with a wired, light emitting, or wireless technology such as Bluetooth. In a best embodiment, discrete sensors will be placed for maximum effectiveness and, if necessary, the sensors could be connected to a commercial wireless network to enable performing functions such as sensing for end-to-end continuity tests.

In a best embodiment, the sensor utilizes the principle of absorption, where a primary fiber emits light from its surface and a proximal, substantially parallel, secondary fiber absorbs a portion of the primary light at openings along its surface. This absorbed light, in turn, illuminates the secondary fiber. Light detectors measure the intensity of light emitted from an end of the secondary fiber, which is used with a mathematical transform to calculate the length, x, of the secondary fiber. The fibers can be of any cross section, e.g., flat primary fibers can be used with round secondary fibers and vice versa.

In another exemplary embodiment, the sensor utilizes the principle of induced luminescence absorption, where a primary fiber emits light from its surface and a proximal, substantially parallel, secondary fiber doped with a luminescent component absorbs a portion of the primary light through its surface. This absorbed light, in turn, induces luminescence in the secondary fiber. A light detector measures the intensity of the luminescence emitted from an end of the secondary fiber, which is used with a mathematical transform to calculate the length, x, of the secondary fiber. The fibers can be of any cross section, e.g., flat primary fibers can be used with round secondary fibers and vice versa.

In yet another exemplary embodiment, the sensor utilizes the principle of reflected induced luminescence absorption of co-doped fiber, wherein ultraviolet light entering into a co-doped primary fiber inside a mirrored coating induces emission of light at a certain wavelength to its surface, which is reflected from the mirrored surface back into a co-doped secondary emitter inside the mirrored coating, which induces light emissions at another wavelength in the co-doped secondary emitter. A light detector measures the intensity of the induced luminescence emitted from an end of the co-doped secondary emitter, which is used with a mathematical transform to calculate the length, x, of the primary emitter.

While the present invention is described mostly in connection with a presently preferred embodiment thereof, those skilled in the art will recognize that any modifications and changes may be made therein without departing from the true spirit and scope of the invention, which accordingly is intended to be defined solely by the appended claims. For instance, in most figures, three distinct sensor elements are shown, but there could be any number arranged in any order. Any person familiar with performing condition based monitoring and prognostic health management will concur that any number of sensors laid in patterns of any non-interfering arrangement can be utilized.

In a best embodiment, the controller is linked by wire or wirelessly to a remote computer such as a commercially available cell phone, Smartphone, tablet, laptop, or desktop model.

All of the embodiments above offer the following advantages over present techniques. The present invention detects many damages other than chafing caused by many causes other than abrasion or incision. It matters not whether the conduit is operating or not operating. The present invention detects stressor attack as well as damage from stressors, because virtually all and every stressor can be sensed by selecting sensitized strands specific to each damaging factor of each stressor. The present invention can be implemented to operate from manual to fully automatic. The present invention can be used to protect as well as monitor systems in addition to conduits. There are applications for the invention to monitor and protect systems and components in solar arrays, electrical generators, energy storage units, aircraft propulsion systems, vehicles, aircraft, and ships.

In a real world embodiment, the sensor means could be posited, without limitation, on the surface of or within entities.

### Construction and Operation

Producing the present invention requires following the teachings herein. Selecting and procuring or making the sensors of translucent material selected for appropriate key parameters such as melting point, transparency, stiffness, bend radius, and doping is key. Creating the sensors is accomplished by, but not limited to, designing a parallel arrangement, i.e., side by side for areas where measuring length is important, of translucent strands in proximity, where strands of an emitter emit light into one or more receptors that receive the emitted light. Another aspect of constructing the system of the present patent is selecting light sources to illuminate the strands, selecting couplings, as well as optional components, such as optical switches and optical repeaters.

Another aspect of producing the present invention is to select the controller with processor means. While the controller and processor can be coupled yet separate, there are numerous small yet powerful controllers with processors to select from that are available from companies such as, but not limited, to Avnet, Altera, Xilinx, Texas Instruments, Intel, and Microsemi. It is also important to select photodetectors biased for optimum measurement of luminosity. Another aspect is selecting or authoring algorithms and rules for execution in the controller. Bench testing a prototype with examples of stressors and different media for the translucent strands, performing tests for operability, and collecting prior data for producing inverse transforms.

The translucent or coated sensors should, if possible, be in proximal contact with the surface of the conduit. If a heat-shrinkable substrate is used, the embodiment is heated appropriately to tightly affix the embodiment to the segments of the interconnection assembly.

Bench testing can only emulate an actual operating environment Therefore, testing in actual conditions is important to achieve reliable results by installing the system components and apparatus onto or into the actual equipment, which the system will instrument, then activate with a suitable power source and check performance against seeded conditions.

In operation, the sensors will be affected by stressors operating on them. End to end testing of the hardware and software means taught by the present invention is probably a good idea. Tests, such as reflectometry, can be used to detect damage to any sensitized media able to carry the waveforms. On detection of said damage, the processor can execute algorithms (such as an inverse transform) for distance calculation, inference of the nature of stressor attack to determine outcomes, and cause of damage, as well as predict future impacts of the damage if damage is allowed to progress. Next, the results of the detection, location, and determination of cause are used to initiate or request actions that mitigate, alleviate or remove the stressor attack or stressors that are the cause of damage as well as corrective actions to bypass, repair, or otherwise deal with the damage. During said actions, the damage to the monitored system is repaired and damaged sections of the sensitized media used in the embodiment of the invention are replaced or repaired.

Many modifications and variations of the present invention are possible in light of the above teachings. Which embodiment to employ depends on the application. The choice should be left to system engineers and experts in operating the systems to be protected. It should be therefore understood that, within the scope of the inventive concept, the invention may be practiced otherwise than as specifically claimed.

### Reduction to Practice

In the course of reducing the invention to practice, we acquired and used several commercially available solid and hollow coated translucent products. We acquired translucent glass and polymer fibers from commercial sources. There are literally hundreds of different commercial translucent fiber products, each with different properties. In reduction to practice, we used translucent strands of styrene, acrylic, and other polymers. Some were doped to emit yellow, red, and green photons. To a substrate, we attached and glued fibers that were of approximately equal diameter in a largely parallel repeated and measureable alignment. Some of the said fibers were a surface-coated with sputtered meta and some had translucent buffers, and some were coated with opaque organic material. We selected an aluminum-plated translucent fiber as a control to differentiate chemical corrosion of aluminum from chafing and cut-through laceration. We selected a silica core optical fiber coated with polyimide insulation as a control.

Next, the film with the attached fibers was wrapped to surround the surface of a conduit consisting of several insulated electrical wires. We recorded the geometry variables for use in accurately measuring the curvilinear distance from the end to a point of damage.

We conducted experiments using seeded damage. The experiments were successful in detecting seeded damage and measuring curvilinear distance to the location of the seeded damage. The experiments consisted of knife cuts causing lacerations. Sensor data collected by the controller was transmitted to the remote computer. We used the Bayesian Inverse transform to determine the curvilinear distance to the seeded damage. A list of references that teach how to use Bayesian Inverse transformation is provided with the present application and these references are included in their entirety by reference herein.

We performed tests with a commercially available, encapsulated marking substance to mark points of damage caused by lacerations, erosion, corrosion, burning, arcing, and dissolution. A person with ordinary skill in the art of using liquid-filled fibers would recognize that, when breached by a stressor, the liquid-filed fiber will leak fluid when a pressure differential occurs and that said pressure differentials are especially common in traversing altitudes of aircraft flight regimes.

### CONCLUSIONS, RAMIFICATIONS, AND SCOPE

The information in this patent disclosure discloses the idea, embodiment, and operation of the invention in order to support the stated claims. The scope of the claims include use of patterns of diverse and different sensitized media formed, laminated, extruded, glued, taped, on or in materials such as insulation and materials used to construct various types of conduits. The types of sensitized media include, but are not limited to, piezoelectric strands, coated and uncoated strands of electrically conductive materials, coated or uncoated strands of optically conductive materials, soluble conductive strands, strands of or coated with base and noble metals, and materials used in waveguides and transmission lines. The various types of conduits include, but are not limited to, harnesses and cables of electrical and fiber optic systems as well as conduits comprised of pipes and hoses carrying liquids, gases and solids.

A person of ordinary skill of utilizing processors and controllers would understand that in any embodiment, one or more additional couplings with another controller or other processor and discrete microsensors can be attached to the instrumentation of the present invention at locations spaced apart from the first coupling, so that differential measurements can be taken at the couplings. The additional information from measurements at another point of the branches will accurately resolve any ambiguities caused by a plurality of sensitized media in a branched tree of conduits.

A person of ordinary skill with using sensors would understand that in the case of very long conduits (perhaps over 1000 meters), it may be necessary to add additional instruments, probably at connectors as determined by the range of effectiveness of individual sensors.

A person of ordinary skill in the art of using translucent fibers will agree that translucent fibers are commercially available in diameters from 100 microns to three millimeters in a variety of compositions, doping, shapes and lengths.

A person with ordinary skill in electrical wiring would understand that in the case of aircraft entities, including but not limited, to control cables, wiring, lubrication, pressurization and fuel conduits, it is reasonable that minimal selection of strands would include those to sense laceration, corrosion, heat, and chafing. Individual hollow strands coated with aluminum to detect corrosion, a material with a positive thermal coefficient to detect heat, and piezoelectric material to detect mechanical chafing would suffice.

A person with ordinary skill in the art of forming translucent pieces, strips, and strands will concur that in many cases a pattern can be embedded into potting compounds, or mounted on the surface of a solid substance, or extruded inside a translucent or opaque substance.

A person with ordinary skill in using sensors would appreciate that discrete sensors to monitor conditions such as, but not limited to, temperature, vibration, and humidity may be nice to have in some alternate embodiments.

A person with ordinary skill in the art of creating strands and their arrangement would appreciate that they can be substituted freely with equivalent components to adapt to specific application requirements.

A person with ordinary skill in the art of using controllers would appreciate and agree that various commercial equivalent controller products, or even a unique design using discrete components, can be substituted freely to adapt to specific application requirements.

A person with ordinary skill in design and use of sensors would agree that it matters not whether any translucent media is used for multiple purposes such as, but not limited to, detecting movement, tensile stress, hot spots, and vibration, because such uses are not conflicting. The said person would agree that media could be selected to collect evidence of causal factors associated with application specific environments.

A person with ordinary skill in the art of creating sensors would understand that an attachment point might be unnecessary, as proximal coupling may be possible. Also, a person with ordinary skill in the art of creating sensors would recognize that the surface and shape of the sensor can be rectangular, round, coiled, or any shape as required by the shape of entity monitored.

A person with ordinary skill in the art of making sensor conduits would understand that the pattern of light conducting elements can be embedded or embossed on an opaque non-light conducting substrate. Alternatively, the pattern of light conducting strands can be extruded or embossed and further, that several embedded layers can be combined with a surface layer if desired.

A person with ordinary skill in the art of optical sensors would understand that mixed sensitized media can be used and formulated for diverse properties such as doping with fluorescent dye, or with a glass core, or with surfaces that could be electrically conductive, corrodible, inert, piezoresistive, piezoelectric, semiconductor, chemically soluble, chemically reactive, etc.

A person with ordinary skill in the art of using translucent materials, such as optical grade glass or plastic fibers, would understand that mixed sensitized media can be used such as optically conductive sensitized media.

A person with ordinary skill in the art of photo sensors would understand that a photo-diode, photo-resistor, or photo-capacitor could be used with any selected wavelength photo-emitters to determine and localize a discontinuity or change in optical impedance in the curvilinear distance of the conduit.

A person with ordinary skill in optical measurement would agree that, while it is possible to make measurements on a terminated and active insulated conduit, it is also possible to make measurements on an un-terminated insulated conduit. Said person would also understand that no signal is added or taken from the conduit. However, the accuracy of measurement is greatest when the distance between the emitter and receptor is small. It will also be understood that measurements can be made over more than one segment with reduced accuracy. It will also be understood that light can be amplified with an optical repeater so that measurements can be made over more than one segment with reduced loss of accuracy. This is consistent with the use of optical repeaters in multiple segments of conduits of long distance fiber optic systems.

A person familiar in the art of florescent illumination of doped fibers would agree that the foreshortening of a fiber doped with a fluorescing material would reduce lumens reflected to the source. The location of the point of damage is accomplished by measuring the amount of lumens sensed at the source. If the distance can be in one of several directions, a one-way optical grating can be used to limit the pass-through of the lumens to a single direction.

A person familiar in the art of optical fibers would agree that products are commercially available with an undoped translucent core, surrounded by a translucent material doped to respond to ultraviolet rays enabling exciting the doped material with one wavelength from the core, produces induced emission of a different wavelength from the doped translucent material.

A person familiar in the art of optical fibers would agree that optical fiber sensors can be made with a translucent core doped to respond to ultraviolet rays surrounded by an undoped translucent material that enables exciting the doped core with one wavelength from the surrounding media that produces induced emission of a different wavelength from the doped core.

A person familiar in the art of optical systems would agree that a photodetector is a generic term for photoresistors, phototransistors, and various other devices that detect and or measure photons and intensity thereof.

A person familiar in the art of optical systems would agree that signal generators are used to produce ranges of wavelengths and intensity for fiber optic systems.

A person familiar in the art of optical systems would agree that photodetectors can measure intensity of light at selected wavelengths and a ranges of wavelengths.

A person familiar in the art of optical systems would agree that light is will transmit axially from and absorb axially through the surface of a translucent strand unless stopped by an opaque coating.

A person familiar in the art of optical systems would agree that formulations of glass and polymers exist that change physical state (i.e., melt) at a wide range of temperatures as well as polymers that dissolve or are oxidized in a wide range of chemicals.

A person familiar in the art of using translucent fibers as sensors would agree that products are available with various types of coatings, buffers, cladding, integral gratings, integral partial mirrors, and doping.

A person familiar in the art of optical systems would agree that photodetector is a generic term for photoresistors, phototransistors, various other devices that detect and or measure photons and intensity thereof.

A person familiar in the art of using optical fibers for communications and sensing would agree that couplings are commonly available to connect fibers to photodetectors and light sources.

A person familiar in the art of using optical fibers would agree that beam splitters, taps, partial mirrors and optical repeaters are commonly used.

A person familiar in the art of optical fibers would agree that products are commercially available with a doped translucent core surrounded by a doped translucent material (co-doped) so the doped core guiding light at one wavelength induces emission of a different wavelength from the surrounding doped translucent material.

A person familiar in the art of making glass and polymer fibers would agree that strands with opaque anodized coatings of metal and opaque polymer coatings are in wide use as well as forming light-reflecting surfaces and mirrored surfaces that improve conducting light through the coated strand.

A person familiar in the art of making glass and polymer fibers would agree that translucent strips and strands, such as fiber, with opaque polymer coatings are in wide use.

A person familiar in the art of making glass and polymer fibers would agree that strands with anodized coatings of metal can be made with a side-emitting feature with opening of up to or exceeding 45 degrees.

A person familiar in the art of optical sensors and sensing would agree that the shape of the strands of translucent material can be circular like that of fibers or any manufacturable shape including, but not limited to, rectangular, square, trapezoidal, parallelograms, and oval.

A person familiar in the art of making glass and polymer fibers would agree that ribbons of combinations of glass and polymer fibers are commercially available. Further, that such ribbons of translucent fibers can be constructed using glues, coatings, or sticky tape.

A person familiar in the art of sensors and sensing would agree that the area of the cross-section of the light conducting material may not be as important as for electrical signals; and may be quite independent of width of the conducting material for optical and fluorescent fibers, especially when evanescent escape is minimal. Further, a person familiar in the art would understand that a decoupler would enable determining in which direction the damage occurred.

A person familiar in the art of sensors would agree that a pattern of sensors described in the current patent can touch if touching is not a source of confounding information such as caused by a metal coating of media potentially causing a metal-to-metal short or interference in a light path.

A person familiar in the art of sensors would agree that a plurality of heterogeneous-doped translucent media in diverse shapes can be used including, but not limited to, filaments, ribbons, strips, or deposits and extrusions.

A person familiar in the art of sensors would agree that the types of translucent media can be homogeneous or heterogeneous, can be made from differing yet compatible materials, and that a coating of fibers with heterogeneous materials including, but not limited to, water soluble, chemically soluble, noble metal, base metal, and insoluble is commonly practiced.

A person familiar in the art of measurements would appreciate that frequentist and Baysian inverse transform methods are widely used; and that Bayesian inverse transforms are probably the most commonly used because of available prior data from testing or experience.

A person familiar in the art of stress attack mitigation, alleviation, and damage prevention would understand that the preferred configuration will result in stress attack detection with annunciation before unsafe conditions and substantial damage.

A person familiar with methods relating to monitoring, detecting and mitigating stress attacks would appreciate the controller could be further configured to adaptively adjust the unsafe condition criterion in response to a changed condition of the protection system or a changed configuration of a system component protected by the protection system.

A person familiar with methods relating to monitoring, detecting, and mitigating stress attacks would appreciate that a system can be configured to measure light and generate a first light signal indicative of the measurement of light and later process signal a second light to verify the unsafe condition based. Further, said person would appreciate that the algorithm can produce an error signal that is generated if the induced unsafe condition event is determined to be an unsafe condition event based on the unsafe condition detection algorithm, and generate an unsafe condition signal if the controller determines that the second signal is indicative of an unsafe condition event.

A person familiar with methods relating to mitigating or stopping stress attacks would appreciate that the system can include an interruption device configured to mitigate the unsafe condition in response an unsafe condition signal.

A person familiar with methods relating to detecting unsafe conditions would appreciate an input device could be configured to selectively to cause the controller to determine the unsafe condition detection algorithm, verify the unsafe condition detection algorithm, or determine whether the second light signal is indicative of an unsafe condition event.

A person familiar with methods relating to detecting unsafe conditions would appreciate the unsafe condition detection algorithm could include a Bayesian algorithm to compute the probability of an unsafe condition.

A person familiar with developing methods relating to detecting unsafe conditions would appreciate the unsafe condition detection algorithm could include a comparison of the first light signature corresponding to the first light signal and a second light signature corresponding to the second light signal to detect a subsequent light altering event, the first light signal and the second light signal being indicative of a fire or arcing or other event.

A person familiar with developing methods relating to detecting unsafe conditions would appreciate the unsafe condition can be communicated, for example, to a fire department or other organization.

A person familiar with methods relating to detecting unsafe conditions would appreciate the criteria for detecting a stress attack could include one or more of a threshold value, a range of threshold values, or a predetermined light signature.

A person familiar with methods relating to sensor data collection and interpretation would appreciate that detecting change of light collected by a receptor could include one or more of a threshold value, a range of threshold values, or a predetermined light signature.

A person familiar with methods relating to sensor data collection and interpretation would appreciate that the method for identifying a precursor to stressor attack or an unsafe condition could include adjusting one or more of the precursor criteria in response to a changed condition of the protection system or a changed configuration of a system protected by the protection system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A system for detecting and determining a location of a potential stressor attack upon an entity, the system comprising:
an instrumentation assembly comprising:
a light source; and
a photodetector for measuring light intensity data;
at least one sensor disposable proximally along a conduit, said sensor having a first end operably coupled to said instrumentation assembly, said sensor comprising:
at least one emitter for axially transmitting light from said light source; and
at least one receptor situated proximal and parallel to said at least one emitter, for receiving light emitted radially from said at least one emitter and for axially guiding transmitting an intensity of light within said receptor to said photodetector;
wherein said photodetector performs measurement of said intensity of received light and outputs a signal indicative of the said intensity of received light;
a controller for executing an algorithm for processing measurement of intensity of light to detect and determine a location of a stressor attack.

2. The system of claim 1, wherein the controller executes an algorithm for processing the signal indicative of the intensity of received light outputted the photodetector to produce a length estimate of the receptor.

3. The algorithm of claim 1, wherein the algorithm is configured to process the length estimate to determine an unsafe condition and to output an unsafe condition signal.

4. The system of claim 1, wherein the controller executes an algorithm that processes an unsafe condition signal and determines to annunciate an unsafe condition.

5. The system of claim 1, wherein the controller processes an unsafe condition signal in combination with other available data to execute a control algorithm to control the unsafe condition.

6. The system of claim 4, wherein when the controller annunciates an unsafe condition the controller executes an algorithm to mitigate the unsafe condition.

7. The system of claim 1, wherein the at least receptor comprises a plurality of receptors positioned proximal to a plurality of said entity.

8. The system of claim 1, wherein the controller executes an algorithm that processes rate of change in the signal to predict a future unsafe condition.

9. The system of claim 1, wherein the controller executes an algorithm to determine cause of an unsafe condition and output a cause of unsafe condition signal.

10. The system of claim 9, wherein the controller executes an algorithm to process a cause of unsafe condition signal to relieve the cause of the unsafe condition signal.

11. An apparatus for monitoring stress attacks on entities comprising:
an instrumentation assembly comprising:
a controller for executing an algorithm for processing light intensity data for detecting stress attacks and determining location of stress attacks;
a light source; and
a photodetector for measuring the light intensity data;
at least one sensor disposable proximally at potential stress attack points, said sensor having a first
end operably coupled to said instrumentation assembly, said sensor comprising:
at least one emitter for axially transmitting light from said light source; and
at least one receptor situated proximal and parallel to said at least one emitter, for receiving light emitted radially from said at least one emitter and for axially guiding light within the receptor to said photodetector;
wherein a potential stressor attack changes light received by the receptor, affecting a change in said intensity of received light within said receptor guided to said photodetector; and
wherein said photodetector measures said change in said intensity and supplies intensity data to said controller.

12. The system of claim 11, wherein when the controller detects a stress attack the controller executes an algorithm to alleviate the stress attack.

13. The system of claim 11, wherein when the controller detects a stress attack the controller executes an algorithm to mitigate effects of the stress attack.

14. The system of claim 11, wherein receptors are positioned proximal to entities with known coordinate information.

15. The system claim 11, wherein the controller executes an algorithm that processes length of receptor data to produce map coordinates of the location of stress attacks.

16. The system claim 15, wherein the controller executes an algorithm that produces information related to unsafe conditions,

17. A system for providing protection from unsafe conditions of an entity comprising:
at least one light receptor configured to accept light and generate a signal indicative of the accepted light;
a controller in communication with said at least one light receptor, the controller being configured to process the signal to determine the existence of an unsafe condition, and generate an unsafe condition signal.

18. The system of claim 17, wherein the controller is configured to determine a probability of an unsafe condition.

19. The controller of claim 17 further comprising using measurements of electrical current and voltage to further characterize the unsafe condition.
